(19) United States
(12) Patent Application Publication
(10) Pub. No.: US 2008/0254277 A1
(43) Pub. Date: Oct. 16, 2008

(54) Process for Manufacturing Cellular Structures Based on Amorphous Thermoplastic Polymers

(75) Inventors: Claude Dehennau, Waterloo (BE); Dominique Grandjean, Brussels (BE)

Correspondence Address: OBLON, SPIVAK, MCCLELLAND MAIER & NEUSTADT, P.C., 1940 DUKE STREET, ALEXANDRIA, VA, 22314, US

(73) Assignee: Solvay (Societe Anonyme), Brussels (BE)

(21) Appl. No.: 12/094,900

(22) PCT Filed: Dec. 12, 2006
(86) PCT No.: PCT/EP2006/069567

§ 371 Date: May 23, 2008

(30) Foreign Application Priority Data
Dec. 14, 2005 (FR) 0512663

(51) Int. Cl. B32B 3/26; B29C 47/76

(52) U.S. Cl. 428/304.4; 264/101

(57) ABSTRACT

Process for manufacturing cellular structure based on a composition comprising an amorphous thermoplastic polymer and made up of sheets extruded in parallel and intermittently welded, according to which:
an amorphous polymer composition is chosen which has a dynamic melt viscosity, measured at its processing temperature and at an angular velocity of 0.1 rad/s, of less than 2000 Pa.s; and
the temperature of the coolant is regulated so that it is at least equal to T_{g}—20° C., where Tg is the glass transition temperature of the composition based on the amorphous polymer.

The present invention relates to cellular structures based on given amorphous thermoplastic polymer compositions. It also relates to a process for manufacturing these structures.

A requirement encountered in many different (automotive, civil engineering, naval, etc.) industries consists in optimizing the mechanical properties/weight ratio of the structures used. Numerous processes have been developed for achieving this objective, and in particular, for lightening plastic structures. Most of these processes use either the mechanical formation of macroscopic cells (by assembly of solid or molten streams in order to form cellular structures known as “honeycomb” structures), or by physical formation of microscopic cells by release or expansion of a gas (expansion or foaming using physical or chemical blowing agents). A combination of the two types of process has also been envisaged.

A process for manufacturing cellular structures by continuous extrusion has been proposed in document EP-B-1 009 625, the contents of which is incorporated for reference in the present description. This process consists in:
continuously extruding, using a multi-slot die, parallel sheets of thermoplastic material into a cooling chamber, with the creation of a seal between the longitudinal edges of the sheets and the walls of the chamber, the various sheets defining, between themselves and with the walls of the chamber, compartments;
creating, in this chamber and from the end located nearest the die, a vacuum in every other compartment, so as to deform and attract, in pairs, the extruded sheets in order to carry out localized welding over their entire height;
filling, from the end located nearest the die, every other compartment, alternating with the previous compartments, using a coolant; and
alternating, in each compartment, the creation of a vacuum and the filling using a coolant, in order to obtain a solidified cellular structure in the cooling chamber, in which the cells are perpendicular to the extrusion direction.

According to this process, the cellular structures obtained are made up of sheets extruded in parallel and intermittently welded that are solid on exiting the cooling chamber. In fact, the consequence of using coolant in the sealed cooling chamber is that this coolant remains in the cell that it has, in a very short time, inflated, welded to the neighbouring cell and solidified. This rapid solidification is essential to the feasibility of the process, as otherwise the cellular structure would adhere to the walls of the cooling chamber.

In addition, the geometry of the die used and also the methods of implementing this process (and especially the use of water as the coolant) are such that only compositions based on very fluid, generally (semi)crystalline, resins may be used. In fact, the compositions based on amorphous polymers (such as PVC) are, and generally remain, relatively viscous, even at high temperature. As a result, the intermittent welding of adjacent sheets is not carried out correctly. Furthermore, the viscous material solidifies rapidly on contact with the water present in the cooling chamber, the sheets are only drawn a little at the die exit, and therefore the cellular structure obtained often has too high a bulk density (expressed as kg per dm³ of structure).

The present invention aims at solving these problems and especially at making it possible to obtain cellular structures based on amorphous polymer materials that are lightweight and have good quality welds, and this being so over a wide range of viscosities and temperatures. It is based on the choice of specific formulations (compositions) of amorphous resins, and also on given processing conditions.

The present invention therefore relates, primarily, to a process for manufacturing a cellular structure based on an amorphous polymer according to which:
parallel sheets of a composition based on said amorphous polymer are extruded continuously, using a multi-slot die, into a cooling chamber, with the creation of a seal between the longitudinal edges of the sheets and the walls of the chamber, the various sheets defining, between themselves and with the walls of the chamber, compartments;
in this chamber and from the end located nearest the die, a vacuum is created in every other compartment, so as to deform and attract, in pairs, the extruded sheets in order to carry out localized welding over their entire height;
from the end located nearest the die, every other compartment, alternating with the previous compartments, is filled using a coolant; and
in each compartment, the creation of a vacuum and the filling using a coolant is alternated, in order to obtain a solidified cellular structure in the cooling chamber, in which the cells are perpendicular to the extrusion direction, this process being characterized in that:
an amorphous polymer composition is chosen having a dynamic melt viscosity of the extruded amorphous polymer, measured at its processing temperature and at an angular velocity of 0.1 rad/s, of less than 2000 Pa.s; and
the temperature of the coolant is regulated so that it is at least equal to T_{g}—20° C., where T_{g} is the glass transition temperature of the composition based on the amorphous polymer.

The thermoplastic polymers being incorporated into the cellular structure composition according to the invention are amorphous polymers. In the present description, the term “amorphous polymer” is understood to define any thermoplastic polymer having predominantly a disordered arrangement of the macromolecules that constitute it. In other words, this term is understood to mean any thermoplastic polymer that contains less than 10% by weight, preferably less than 5% by weight, of crystalline phase (that is to say, the phase characterized by a melting endotherm during differential thermal analysis (DSC) measurements). Preferably, the compositions based on amorphous polymer(s) used in the invention have a glass transition temperature (T_{g}) (that is to say, the temperature below which the composition passes from the soft and flexible state to a hard and brittle state), conventionally measured by DSC, of less than 80° C., or even less than 60° C., and preferably less than 40° C. As will be seen later on, this choice makes it possible, during processing, to use water as the coolant.

Nonlimiting examples of amorphous polymers which may be used in the compositions according to the invention are:
thermoplastic elastomers, and also blends thereof,
thermoplastic polyesters;
homopolymers and copolymers derived from vinyl chloride, and also blends thereof.

The amorphous polymers preferred according to the present invention belong to the family of homopolymers and copolymers derived from vinyl chloride (VC). The term “copolymers derived from vinyl chloride”, is understood to mean, in the present description, copolymers containing at least 70% by weight of monomer units derived from vinyl chloride. Copolymers containing about 75 to about 95% by weight of vinyl chloride are preferred. As examples of comonomers that are copolymerizable with vinyl chloride, mention may be made of unsaturated olefin monomers, such as ethylene, propylene and styrene and esters such as vinyl acetate and alkyl acrylates and methacrylates. Copolymers of vinyl chloride and vinyl acetate give good results (VC/VAc copolymers).

Compositions based on amorphous polymers that can be used according to the present invention must have a dynamic melt viscosity (measured conventionally via measurements of the shear stress and strain on a rheogoniometer), at their processing temperature (that is to say at the temperature at which they are extruded in order to be converted into cellular structures) and at an angular velocity of 0.1 rad/s, of less than 2000 Pa.s. Preferably, this dynamic viscosity is less than 1000 Pa.s. The best results are obtained with compositions of which the dynamic viscosity is less than 500 Pa.s.

Generally, such a low viscosity cannot be obtained with commercially available amorphous polymers without recourse to additives having a viscosity lowering effect. In particular in the case of VC polymers, these are generally monomeric or polymeric plasticizers. As nonlimiting examples of such plasticizers, mention may be made of phthalates (such as dibutyl or diethylhexyl or dioctyl phthalates), sebacates, adipates, trimellitates, pyromellitates, citrates, epoxides (such as epoxidized soybean oil or ESO for example) and polyesters such as poly(ε-caprolactone) and blends thereof. DOP (dioctyl phthalate) and ESO give good results. These compositions contain, in general, at least 10 parts and up to 75 parts by weight of plasticizer per 100 parts by weight of polymer. It is namely so that the process of the invention allows the formation by extrusion of structures which are based on compositions that would “sag” (fall under their own weight) in the processes of the prior art. In other words: it allows to incorporate at least 10 parts by weight (per 100 parts by weight of polymer) of plasticizer, and even at least 30 parts, and even up to 75 parts indeed of plasticizer in compositions intended for cellular structures obtained by extrusion, without any problem of “sagging”.

Vinyl chloride polymers, known as “internal plasticization polymers”, may also be used, that are obtained by copolymerization of vinyl chloride with plasticizer comonomers, such as for example ethylhexyl acrylate, or else by copolymerization with grafting onto the polymers known as “elasticizers” such as poly(ε-caprolactone).

It is understood that the compositions according to the invention may comprise, in addition to plasticizers, other common polymers and/or additives used for processing polymers, such as, for example, lubricants, heat stabilizers, light stabilizers, inorganic, organic and/or natural fillers, pigments, etc.

The compositions more particularly preferred according to the present invention are those based on vinyl chloride copolymers containing from 5 to 25% by weight of vinyl acetate, plasticized by 10 to 30% by weight of a plasticizer such as DOP or ESO.

A blowing agent may also be present, making it possible to produce expanded or foamed cellular structures.

The blowing agent according to this variant of the present invention may be of any known type. It may be a “physical” blowing agent, that is to say a gas dissolved in the plastic under pressure and which causes the plastic to expand as it leaves the extruder. Examples of such gases are CO₂, nitrogen, steam, hydrofluorocarbons or HFCs (such as the 87/13 wt % CF₃—CH₂F/CHF₂—CH₃ mixture sold by Solvay as SOLKANE® XG87), hydrocarbons (such as butane and pentane) or a mixture thereof. It may also be a “chemical” blowing agent, that is to say, a substance (or a mixture of substances) dissolved or dispersed in the plastic and which, under the effect of the temperature, releases the gas or gases that will be used for the expansion of the plastic. Examples of such substances are azodicarbonamide and mixtures of sodium bicarbonate and citric acid. The latter give good results.

The amount of blowing agent used in the process according to this variant of the invention must be optimized, especially according to its nature, to the properties (especially dynamic viscosity) of the polymer present and to the desired final density. In general, this content is greater than or equal to 0.1%, preferably 0.5%, or even 1%.

According to a preferred embodiment, the temperature of the coolant is regulated so that it is at least equal to T_{g} minus 15° C. and in a more particularly preferred way, to T_{g} minus 5° C. The temperature of the coolant may even (when it is possible, considering the nature of said fluid and the T_{g}) be greater than T_{g} (for example, at least 30° C., or even at least 40° C. and higher still).

In the present description, the term “coolant” is understood to mean any liquid capable of sufficiently chilling the cellular structure so as to permanently solidify it in the cooling chamber. This coolant is preferably water. This fluid is generally at a temperature between 20 and 50° C., preferably between 25 and 40° C. All other conditions being equal moreover, an increase in the temperature of the cooling water leads to a lightening of the cellular structures obtained. In practice, it is preferable to prevent the coolant from freezing or from being brought to a temperature such that its vapour pressure reaches a value which prevents a good vacuum from subsequently being generated for the extruded sheets (for example above about 80° C. for water, or yet even 65-70° C.). Therefore, as already mentioned above, the choice of temperature of the coolant depends on the T_{g} of the composition based on the amorphous polymer used according to the process of the invention. In fact, if this T_{g} is high, the temperature of the coolant must paradoxically (despite its name) also be high. In particular, water is therefore especially suitable for polymers having a T_{g} of less than 60° C., or even 40° C. Especially in the case of the compositions based on plasticized VC/VAc copolymers already mentioned previously, the coolant is preferably water at a temperature between 20 and 50° C.

Other details on the process for manufacturing cellular structures according to the invention, and on the equipment making it possible to produce it, may be found in document EP-B-1 009 625.

The cellular structure obtained by the manufacturing process according to the invention may advantageously be taken up, after its formation, by a take-off unit. The haul-off speed and the extrusion rate will be optimized, especially according to the size and thickness of the cells, and also to the desired shape.

On leaving the take-off unit, the cellular structure may be subjected to a surface treatment (a corona treatment, for example), so as to improve the adhesion properties thereof in particular, and be lined with a nonwoven or with top and bottom facings. At the end of these optional operations, the final panel is cut both lengthwise and widthwise into sheets of the desired dimensions and stored.

The production scrap may be taken up either before the finishing operations, or afterwards, and recycled back into production.

The extrusion conditions of the process according to the present invention are adapted, in particular, to the nature of the amorphous polymer. As mentioned previously, the temperature of the composition based on said polymer, at the die exit, must, in particular, be adapted so as to be able to weld the cells, to expand the composition where appropriate, etc. in the absence of deformation due to gravity. The alternating pressure and vacuum values must also be adapted, and also the duration of the cycles, so as to optimize this welding. In practice, preferably a pressure greater than or equal to 0.5 bar relative, or even 1.5 bar, is used. This pressure is generally less than or equal to 6 bar, or even 4 bar, or even more so, 2 bar. As regards the vacuum, this is generally greater than or equal to 100 mmHg absolute, or even 400 mmHg. Finally, the duration of the cycles (pressure/vacuum alternations) is generally greater than or equal to 0.3 s, or even 0.4 s, preferably 0.5 s. This duration is preferably less than or equal to 3 s, or even 2 s, and even more so, 1 s.

In the process according to the invention, the shape and size of the cells may be adapted by modifying the melt viscosity of the polymer, the extrusion speed, the duration of the pressure/vacuum cycles, etc.

The shape of the cells of this structure may be approximately circular, elliptical (when the extrusion and/or haul-off speeds are higher), polygonal (when the pressure differences applied are more sudden), etc.

These cells generally have a length L (in the extrusion direction) greater than their width l (in the extrusion plane but along a direction perpendicular to that of the extrusion). In general, the aspect ratio (L/l) of the cells is therefore greater than 1, or even 1.5, but generally less than 2.

The length (L) of the cells is generally greater than or equal to 4 mm, or even 10 mm, but generally less than or equal to 30 mm, or even 20 mm. The width (l) is itself generally greater than or equal to 2 mm, or even 5 mm, but generally less than or equal to 15 mm, or even 10 mm.

The size of the cellular structures obtained by the process according to the invention is limited by the size of the processing equipment. The term “size” is understood in fact to mean only the width and the height (measured perpendicularly at the extrusion plane), and not the length since that is determined by the duration of the extrusion and the frequency at which the extruded sheet is cut. The height of these structures is generally greater than or equal to mm, or even 2 mm, preferably 5 mm; it is generally less than or equal to 70 mm, or even 60 mm.

It follows from the foregoing that the present invention makes it possible to obtain one-piece cellular structures of which the length can be varied up to infinity and this being so with a wide range of amorphous polymers.

The cellular structures obtained by the process according to the invention are advantageously used in the building industry (lightweight ceilings, partitions, doors, formwork for concrete, etc.), in furniture, in packaging (side protections, wrapping of objects, etc.), in motor vehicles (parcel shelves, door interiors, etc.), etc. These structures are particularly suitable in the building industry, for the construction of permanent shelters (dwellings) or temporary shelters (rigid tents or humanitarian shelters, for example).

They may be used therein as such or as a sandwich panel between two sheets known as facings. The latter variant is advantageous and, in this case, said sandwich panel may be manufactured by welding, bonding, etc. or any other method of assembling the facings and the core (used cold or hot, just after extrusion) that is suitable for plastics. One advantageous way of manufacturing said sandwich panel consists in welding the facings to the cellular core. Any welding process may be suitable for this purpose, the processes using electromagnetic radiation giving good results in the case of structures/facings that are at least partially transparent to electromagnetic radiation. Such a process is described, for example, in French Patent Application 03/08843 the content of which is incorporated for reference in the present description.

According to another aspect, the present invention also concerns a cellular structure based on a composition comprising a thermoplastic polymer, susceptible to be obtained according to a process as described above and being made up of sheets extruded in parallel and intermittently welded, characterized in that said polymer is an amorphous polymer chosen between homopolymers and copolymers derived from vinyl chloride (VC) and in that said composition comprises a monomeric or a polymeric plasticizer.

The present invention is illustrated, in a nonlimiting manner, by the following examples.

### EXAMPLE 1

A cellular structure with a width of 4 cm and a height of 12.2 mm was extruded under the conditions and using the device described below:
SCAMEX 45 extruder supplied with 5 separate heating zones (Z1 to Z5) and equipped with a die as described in the document EP-B-1 009 625, with 3 heating zones heated to 160° C. The die opened directly into the cooling water and was equipped with a water-based pressure and vacuum system for ensuring the welding as described in the document EP-B-1 009 625;
temperature profile in the extruder:
   Z1: 109° C.
   Z2: 145° C.
   Z3: 156° C.
   Z4: 154° C.
   Z5: 155° C.
composition based on the amorphous polymer used: copolymer containing 85% by weight of polymerized vinyl chloride and 15% by weight of polymerized vinyl acetate, plasticized with 20% by weight of dioctyl phthalate;
dynamic viscosity of the amorphous polymer at 0.1 rad/s and 160° C.: 859 Pa.s;
T_{g} of the amorphous polymer: 35° C.;
material temperature at the die inlet: 160° C.;
extrusion pressure: 9 bar;
screw speed: 30 rpm;
water pressure: 1.5 bar;
vacuum: 400 mmHg;
duration of the pressure/vacuum cycles: 0.5 s/0.5 s;
draw ratio: 65%; and
temperature of the cooling water: 35° C.

A cellular structure of regular geometry was obtained having the following properties:
height: 12.2 mm; and
bulk density: 0.27 kg/dm³.

### EXAMPLE 2R

### Comparative Example, Not Conforming to the Invention

It was attempted to extrude a cellular structure under the conditions and with the device described in Example 1, but using a polymer composition based on vinyl chloride of which the dynamic viscosity at 0.1 rad/s and at the processing temperature (200° C.) was 6624 Pa.s and the T_{g} was 85° C.

It was impossible to convert the extruded sheets into a cellular structure.

### EXAMPLE 3R

### Not Conforming to the Invention

A cellular structure with a width of 4 cm and a height of 10 mm was extruded using the device described in Example 1 and under specific conditions below:
heating zones of the SCAMEX 45 extruder heated to 210° C.;
temperature profile in the extruder:
   Z1: 111° C.
   Z2: 158° C.
   Z3: 194° C.
   Z4: 194° C.
   Z5: 204° C.
composition used: as in Example 2R;
material temperature at the die inlet: 211° C.;
extrusion pressure: 43 bar;
screw speed: 13 rpm;
water pressure: 1.5 bar;
vacuum: 400 mmHg;
duration of the pressure/vacuum cycles: 0.75 s/0.75 s;
draw ratio: 60%; and
temperature of the cooling water: 60° C.

A cellular structure of irregular geometry (cells with walls of variable thickness) was obtained having the following properties:
height: 10 mm; and
bulk density: 0.590 kg/dm³.

The results of these examples show that when a composition is used based on an amorphous polymer whose T_{g} and dynamic viscosity are too high and when the difference between the T_{g} and the temperature of the cooling water is too great (Example 2R), it is impossible to obtain a cellular structure. If the temperature of the cooling water is increased (Example 3R), it is possible to obtain such a structure but the latter has an irregular geometry and a very high bulk density.

1. A process for manufacturing a cellular structure based on an amorphous polymer, according to which:
parallel sheets of a composition based on said amorphous polymer are extruded continuously, using a multi-slot die, into a cooling chamber, with the creation of a seal between the longitudinal edges of the sheets and the walls of the chamber, the various sheets defining, between themselves and with the walls of the chamber, compartments;
in this chamber and from the end located nearest the die, a vacuum is created in every other compartment, so as to deform and attract, in pairs, the extruded sheets in order to carry out localized welding over their entire height;
from the end located nearest the die, every other compartment, alternating with the previous compartments, is filled using a coolant; and
in each compartment, the creation of a vacuum and the filling using a coolant is alternated, in order to obtain a solidified cellular structure in the cooling chamber, in which the cells are perpendicular to the extrusion direction,
this process being characterized in that:
an amorphous polymer composition is chosen having a dynamic melt viscosity, measured at its processing temperature and at an angular velocity of 0.1 rad/s, of less than 2000 Pa.s; and
the temperature of the coolant is regulated so that it is at least equal to T_{g}—20° C., where T_{g} is the glass transition temperature of the composition based on the amorphous polymer.

2. The process according to claim 1, wherein the composition based on the amorphous polymer has a glass transition temperature (T_{g}) of less than 60° C.

3. The process according to claim 1, wherein the amorphous polymer is chosen from homopolymers and copolymers derived from vinyl chloride (VC).

4. The process according to claim 3, wherein the amorphous polymer is a copolymer of vinyl chloride and vinyl acetate (VC/VAc copolymer).

5. The process according to claim 3, wherein the polymer composition comprises a monomeric or polymeric plasticizer.

6. The process according to claim 5, wherein the plasticizer is epoxidized soybean oil (ESO) or DOP (dioctyl phthalate).

7. The process according to claim 6, wherein the composition is based on a vinyl chloride copolymer containing from 5 to 25% by weight of vinyl acetate, plasticized by 10 to 30% by weight of DOP or ESO.

8. The pProcess according to claim 1, wherein the coolant is water.

9. The process according to claim 8, wherein the water is at a temperature between 20 and 50° C.

10. A cellular structure based on a composition comprising a thermoplastic polymer, susceptible to be obtained according to a process according to claim 1 and being made up of sheets extruded in parallel and intermittently welded, wherein the said polymer is an amorphous polymer chosen between homopolymers and copolymers derived from vinyl chloride (VC) and wherein the composition comprises a monomeric or a polymeric plasticizer.
